(19) United States
(12) Patent Application Publication
(10) Pub. No.: US 2021/0056590 A1
(43) Pub. Date: Feb. 25, 2021

(54) SYSTEM FOR CREATING AND ENHANCING TARGETED ADVERTISING OPPORTUNITIES BASED ON THE COLLECTION AND PROCESSING OF REUSABLE AND RECYCLABLE MATERIALS

(71) Applicant: Matthew P. Berry, Columbus, OH (US)

(72) Inventors: Catherine L. Berry, Palm Beach, FL (US); Matthew P. Berry, Columbus, OH (US)

(21) Appl. No.: 16/990,032

(22) Filed: Aug. 11, 2020

Related U.S. Application Data
(63) Continuation of application No. 14/830,298, filed on Aug. 19, 2015, now abandoned.
(60) Provisional application No. 62/180,763, filed on Jun. 17, 2015.

(51) Int. Cl. G06Q 30/02; G06Q 10/00

(52) U.S. Cl. CPC G06Q 30/0269; Y02W 90/00; G06Q 10/30; G06Q 30/0276

(57) ABSTRACT

A fully or partially automated system and associated method for generating revenue from targeted advertising based on user-determined processing of recyclable or reusable materials. Personal information about the user further includes objective criteria such as demographic information and subjective criteria based on individual preferences. Processing a container of re-usable material includes determining an objective value of the re-usable materials based on current market value for the re-usable materials and a user quality appraisal factor that is derived from an assessment of the user's history with regard to quality and type of re-usable material placed in the containers.

### CROSS-REFERENCE TO RELATED APPLICATIONS

This patent application is a continuation of U.S. patent application Ser. No. 14/830,298 filed on Aug. 19, 2015 and entitled “System for Creating and Enhancing Targeted Advertising Opportunities Based on the Collection and Processing of Reusable and Recyclable Materials”. U.S. patent application Ser. No. 14/830,298 claimed the benefit of U.S. Provisional Patent Application Ser. No. 62/180,763 filed on Jun. 17, 2015 and entitled “Automated System and Method for Creating and Enhancing Target Advertising Opportunity”. The disclosures of these applications are all hereby incorporated by reference herein in their entirety and made part of the present U.S. utility patent application for all purposes.

### BACKGROUND OF THE INVENTION

The described invention relates in general to a system and method for generating revenue based on targeted advertising, and more specifically to a fully or partially automated system and associated method for generating revenue from targeted advertising based on user-determined processing of reusable materials.

In modern industrialized societies, most households and business typically generate, on a regular basis, significant amounts of re-usable or recyclable materials, ranging from common metals, glass, paper, and plastics to clothing, furniture, computer and electronic equipment, and numerous other items. Gathering and processing these materials and/or items may be random events or may occur on a more regular basis, as with many recycling programs sponsored by local governments. However, other than city-sponsored recycling and/or re-use programs, there are few, if any, systems that provide households and business with incentives for recycling and re-use beyond simply reducing the amount of physical waste that must be removed and reducing (in some cases) the cost associated with the removal of such waste. Furthermore, the absence of programs that provide households and business with containers specifically intended for gathering re-usable and/or recyclable materials represents a lost opportunity with regard to placing targeted advertising directly in a household or in a business. Accordingly, there is an ongoing need for a system and method for incentivizing recycling and re-use and for providing advertising opportunities as an aspect of incentivized recycling.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with an exemplary embodiment of the present invention, a method for creating and enhancing targeted advertising opportunity based on a dynamic user-specific profile is provided. This method includes: (a) determining an initial price for advertising at least one product or service; (b) using a data processor operated by a system administrator, creating a user account that includes and initial user profile, wherein the initial user profile further includes personal information about the user, and wherein the personal information about the user further includes: (i) objective criteria, wherein the objective criteria further includes demographic information; and (ii) subjective criteria based on individual preferences; and (c) providing the user with a container for collecting and storing a predetermined type of re-usable material, wherein the container includes identifying indicia regarding the contents of the container, and wherein the container further includes advertising for at least one product or service; (d) collecting the container of re-usable material after the container has been filled with re-usable material by the user; (e) processing the container of re-usable material, wherein processing the container of re-usable material includes: (i) determining an objective value of the re-usable materials based on: a) current market value for the re-usable materials; and b) a user quality appraisal factor, wherein the user quality appraisal factor is derived from an assessment of the user's history with regard to quality and type of re-usable material placed in the containers; and (ii) reconciling the value of the re-usable materials to reflect the actual value of the re-usable materials, wherein the actual value is derived from what a third party agrees it will pay for the re-usable materials; (iii) trading the re-usable materials to a third party for a price based on the actual value of the re-usable materials; (iv) applying a portion of the actual value of the traded re-usable materials to the user account; (v) applying a portion of the actual value of the traded re-usable materials to executing one or more subjective criteria listed in the initial user profile; (vi) notifying the user that the subjective criteria has been executed; and (vii) acquiring input from the user regarding the user's perception of the execution of the subjective criteria, wherein the input represents a subjective value associated with the user's experience of processing the container of re-usable materials; and (f) using a data processor, transforming the initial user profile into a transformed user profile based on the objective value associated with the container of re-usable materials and the subjective value associated with the user's experience of processing the container of re-usable materials; and (g) providing the user with another container for collecting and storing a predetermined type of re-usable material, wherein the container includes advertising for at least one product or service, wherein the nature of the advertising has been adjusted based on the transformed user profile, and wherein revenue is realized by the system administrator by providing advertisers with enhanced opportunity based on the transformed user profile.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a flowchart of an automated method for creating and enhancing advertising opportunity based on the collection of processing of reusable and/or recyclable material, in accordance with an exemplary embodiment of the present invention;

FIG. 2 is a flowchart of the process of transforming the user profile, in accordance with an exemplary embodiment of the present invention;

FIG. 3 is a flowchart of the user decision model, in accordance with an exemplary embodiment of the present invention;

FIG. 4 is a flowchart of the data link architecture (efficient route networks), in accordance with an exemplary embodiment of the present invention;

FIG. 5 is a flowchart of the for-profit CUAR trade path model, in accordance with an exemplary embodiment of the present invention; and

FIG. 6 is a flowchart of the non-profit CUAR trade path model, in accordance with an exemplary embodiment of the present invention.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### DETAILED DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

A system and method are described for calculating User (Profile) Value in determining advertising pricing based on a User (Profile) transformed by the Complete Reuse System (CRS) trade experience. A purpose-specific unique container bearing brand-with-image partner messaging is the advertising delivery mechanism. Durable and non-durable consumer goods transitioning after use from consumer units are packaged in these purpose-specific unique containers. Therefore, in addition, the system addresses the problem of waste. The purpose-specific unique container is called a CUAR, a “Complete Unit of Advertising and Reuse”. The CUAR is designed to display brand-with-image partner messaging while reusable materials move efficiently and productively through the restorative materials trade market. The system centralizes 2 the trading of these purpose-specific containers or CUARS and directs the contents of these containers for restorative use. Some examples of restorative uses are, but not limited to, donations of goods to non-profit organizations, donation of goods for social and disaster relief, durable material recycling, durable material collection for reuse, and waste used to generate energy. The system distributes wealth credits to the User from the proceeds of the CUAR trade. Some of these wealth credits might be, but not limited to, monetary, environmental, and self-actualization valuations quantified programmatically by way of the system administrator. The User's realization of these values results in measurable effects of the User's system experience; effects that are valued by advertisers. Also, the value of the User's system experience is quantified programmatically by way of the system administrator to explain, for example, cognitive, physical, and emotional effects relative to the experience (an experience accompanied by a brand-with-image partner message). The User Profile is updated with these realized values. Thus, presenting a higher-value system User experience equates a higher value advertising opportunity.

A system and method are described for calculating User (Profile) Value in determining advertising pricing. A CUAR (i.e., purpose-specific, unique containers bearing brand-with-image partner messaging) is the advertising delivery mechanism. Durable and non-durable consumer goods transitioning after use from consumer units are packaged in these purpose-specific unique containers. CPM (Cost/1000): Cost per 1000 often abbreviated to CPM, means that advertisers pay for every thousand displays of their message to potential customers. Ad displays are usually called “impressions”. “Native Advertising” is a form of paid media where the ad experience follows the natural form and function of the user experience in which it is placed. Native ads match the visual design of the experience they live within and look and feel like natural content. Native ads should behave consistently with the native user experience, and function as natural content functions.

A User Account is established and maintained on the system server. A unique ID (TBD) is attached to the User account. The uniqueness of the ID provides certain public information. The required User information is typically the physical address of the User's consumer unit (aka home), an email address, and password for User access to their system account. The User might be prompted to inform the system of, but not limited to: The name, age, gender, level of education, of the occupants in the User consumer unit. Database: Additional relevant User demographics may be obtained from public and private databases. Other information includes options for distributing currency value credits accumulated as a function of the User Account such as payment to User by way of deposit to a bank account, issuance of (bank, gift) card, forwarding currency value to the User's choice of a non-profit as the beneficiary of trade proceeds. Subjective criteria based on individual preferences include personal values, personal interests, likes and dislikes, important social causes, important environmental causes, philanthropic memberships, approbation (sanctioning) of call-to-action campaigns.

Within the context of this invention, the Complete Unit of Advertising and Reuse (CUAR) is explained as follows. Durable and non-durable consumer goods transitioning after use from consumer units are packaged in purpose-specific unique containers. The purpose-specific unique container is called a CUAR, a Complete Unit of Advertising and Reuse. The CUAR is designed to display brand-with-image partner messaging while reusable materials move efficiently and productively through the restorative materials trade market. The physical structure of the CUAR is a basic container, box or bag, durable enough to hold several pounds and survive shipping. The exterior of the CUAR is printed with insignia representing sponsoring partnered advertisers. In addition, insignia on the exterior identifies the (intended) contents of the CUAR. Content representational insignia might identify, but not limited to; Textiles, Metal, Plastics, Paper, Electronics, Batteries, Non-perishable Food, Compostable Waste. The content representational insignia might also include an average estimated weight of a filled CUAR. Thus, a scan of the CUAR content insignia would read, for example, Contents: Paper; Weight: 25 lbs. The system centralizes the trading of these purpose-specific containers or CUARS and directs the contents of these containers for restorative use. Some examples of restorative uses are, but not limited to, donations of goods to non-profit organizations, donation of goods for social and disaster relief, durable material recycling, durable material collection for reuse, and waste used to generate energy.

With regard to CUAR distribution, CUARs are typically delivered at no charge to a requesting consumer unit after establishing a system User Account. In some cases the request to establish a User account and for delivery of (empty) CUARs can be made as a result of a campaign to introduce the system, the recommendation of an acquaintance, in response to a call-to-action or a response to a specific event. In addition, an intentional scan of the system logo displayed on a CUAR or on other official system assets (i.e., marketing materials) grants access to the system's website and the ability to create a User Account and receive (empty) CUARs. Also, automatic replenishment of CUARS is an option for registered system User.

With regard to native advertising and the placement of CUARS in the consumer unit, CUARS are placed in the consumer unit (aka home) based on function and form. While in the state of placement the advertising message on the CUAR is repeatedly being viewed and touched by the occupants of the User unit. For example, the specific purpose of a CUAR placed in the kitchen is to advertise brands whose products function in the kitchen and to demonstrate a coalition with a non-profit image partner. Additionally, the CUAR functions to collect the remnants of kitchen products after use for trade or for donation. Another example: The specific purpose of a CUAR placed in the realm of the bedroom (incl. closet) is to advertise brands whose products are used and stored in the realm of the bedroom (incl. closet), (i.e., textiles, clothes, shoes, jewelry) and to demonstrate a coalition with a non-profit image partner. Additionally, the CUAR functions to collect these goods after use for trade or for donation. Yet, another example would be the specific purpose of a CUAR placed in an office or den is to advertise product brands (i.e., supplies, printers, and electronics) that function in a work or study environment and to demonstrate a coalition with a non-profit image partner. Additionally, the CUAR functions to collect these products post-use for trade or donation.

With regard to CUARS packed with durable and non-durable goods, the following is relevant. While in the state of placement the advertising message on the CUAR is repeatedly being viewed and touched by the occupants of the User unit. The CUAR is filled or “packed” with durable or non-durable goods no longer serving their best, most useful consumption purpose in the consumer unit (i.e., home). An example might be a CUAR placed in the realm of the bedroom is packed with clothing no longer needed or desired, but needed and desired by a non-profit. Also, a CUAR placed in the kitchen might be used to collect non-perishable food items for a local food pantry. The system has informed the User that there is monetary, environmental, and self-actualization values potential in the action of packing the CUAR for trade. Information regarding the monetary and environmental values of the CUAR is dynamic and public as functions of market exchanges. The data input from these market exchange supports the system administrator to predict pre-trade monetary, environmental, and self-actualization values. In some cases, the system has informed the User of these values as a result of a campaign to introduce the system, the acclamation of an acquaintance, or in the system presenting a call-to-action or presenting a specific event. The advertiser is visually and cognitively connected to these values, monetary, environmental, and self-actualization values, while the User is packing a CUAR.

Regarding the definition of consumer unit (CU): for the purpose of estimating consumer expenditure, a CU may comprise of (1) all members of a household related by blood, or by a legal arrangement such as marriage or adoption, (2) financially independent individual living alone, sharing a house, as a roomer in a private home, or in living quarters of a hotel or motel, or (3) two or more individuals living together, pooling their income, and jointly making expenditure decisions. Seven major components of spending include: food, housing, apparel and services, transportation, healthcare, entertainment, and personal insurance and pensions.

Regarding the definition of durable goods, in economics, a durable good or a hard good is a good that does not quickly wear out or more specifically, one that yields utility over time rather than being completely consumed in one use. Items like bricks could be considered perfectly durable goods because they should theoretically never wear out. Highly durable goods such as refrigerators, cars, or mobile phones usually continue to be useful for three or more years of use so durable goods are typically characterized by long periods between successive purchases. Examples of consumer durable goods include cars, household goods (home appliances, consumer electronics, furniture, etc.), sports equipment, and toys.

Regarding the definition of non-durable goods, nondurable goods or soft goods (consumables) are the opposite of durable goods. They may be defined either as goods that are immediately consumed in one use or ones that have a lifespan of less than 3 years. Examples of nondurable goods include fast moving consumer goods such as cosmetics and cleaning products, food, fuel, beer, cigarettes, medication, office supplies, packaging and containers, paper and paper products, personal products, rubber, plastics, textiles, clothing and footwear. While durable goods can usually be rented as well as bought, nondurable goods generally are not rented. While buying durable goods comes under the category of Investment demand of Goods, buying Non-Durables comes under the category of Consumption demand of Goods (Bureau of Labor & Statistics).

The CRS system is a new model: one service with many users making decisions. The system answers new demands for a sustainable environment, the reusables industry revolution, and other social impact goals. The system is economically viable for every home otherwise known as a consumer unit (CU), because the system is typically free, and ties incentives and grants user rewards by way of existing financial markets. Users experience a magnitude of effects both objective and subjective. Rewards are financial, emotional, and social; rewards that greatly impact quality of life. The system takes advantage of technological discontinuities (new technology, i.e. mobile) realizing a meaningful connection of off-line life to the digital, on-line life for the user. The system extends and rewards society's established recycling behavior by incentivizing users financially and emotionally to segregate high-value recyclables, reusables and waste after consumption, into units for trade known as CUARS, or Complete Units of Advertising Reuse; trades that reap benefits from the CUAR'S highest value use. The system processes also evoke the “impulses from the best self”. Once the system administrator notifies the User of the estimated objective and subjective values of trading the filled and collected CUAR the User takes action, or in other words, makes a decision based on the established criteria in the User Profile. The User becomes engaged as the communication flows detailing the impact of participating regarding revenue opportunities, good citizenship rewards, self-actualization benefits, and purpose beyond profit aspects.

Regarding user demand and demand theory, demand-pull innovations are driven by the goals of either satisfying current customer needs in an entirely new way or satisfying new needs. Demand-pull innovations result in a shift of the demand curve, implying an increase in consumers' willingness to pay and thus a greater value creation. The system of this invention is an innovative response to latent consumer demands for making more sense out of waste, and environmental and social well-being. The system defines what consumers are looking for and shapes system participation criteria while revolutionizing post-consumption material handling. Access to the system, an innovative, new wealth market, makes the existing post-consumption material handling model obsolete. Using existing infrastructure, the system centralizes trading of CUARs transitioning from the home to post-consumption materials management companies and grants wealth credits for the trades.

The system and method also ties incentives to participating and gives the user notice of these earned wealth credits granted by established financial markets including, but not limited to, Non-Profits donation receipts, Materials Recycling Facilities high-value recyclable receipts, Waste-to-Energy Plants credits that lower waste utility bills, Retail discounts, time-savings and free shipping valuations, IRS tax deduction receipts, and Commodity Exchanges trade receipts. The system also informs the User that there is monetary, environmental, and self-actualization values' potential in the action of packing and processing the CUAR for trade. In some cases, the system has informed the User of these values as a result of a campaign to introduce the system, the acclamation of an acquaintance, or in the system presenting a call-to-action or presenting a specific event. Information regarding the monetary and environmental values of the CUAR is dynamic and public as functions of market exchanges. The data input from these market exchanges supports the system administrator to predict pre-trade monetary, environmental, and self-actualization values and appraised, post-trade values credited to the User's system account.

Objective benefits of the present invention include financial rewards. The system ties incentives and pays user rewards by means of established financial markets such as: IRS tax credits; non-profits donation receipts; materials recycling facilities high-value recyclable receipts; waste-to-energy plants credits that lower waste utility bills; stock exchange revenue opportunities (reduced externalities as redistribution requires less energy, less water, and other resources than manufacturing new); commodity exchanges trade fees; convenience/time savings; and retail rebates and discounts. Subjective benefits of the present invention include: self-actualization; and social/environmental/emotional factors such as purpose beyond profit; recognition of the poor by reaching the base-of-the-pyramid market; social and disaster relief; and user participation evokes JOY, the most desired emotion, to further direct the experience of the User into action and reinforce engagement.

Once filled or packed and ready for shipping, the User scans the content identification insignia of the CUAR, with a mobile phone and presents a request for pick-up to the system. A request by the system User for a CUAR no-charge pick-up creates the opportunity to trade the CUAR at its highest value use and triggers a suite of activities to be executed by the system administrator. These activities might include, but are not limited to: Granting User access to their system account. Simultaneously, the User's scanning mechanism, likely a mobile phone, measures User's metabolic attributes such as heart rate, body temperature, (to be determined) and continues to measure metabolic attributes as the system prompts the User to respond to questions about the CUAR trade opportunity experience. The system administrator programmatically evaluates the User's metabolic attributes and voluntary answers to system questions in relation to, for example, cognitive, physical, and emotional effects relative to the experience. The system updates the User profile with these measured effects.

The CUAR is stored until being placed at the curb for pick-up. While in the state of storage the advertising message on the CUAR is repeatedly viewed and touched by the occupants of the User unit. Thus, the User is repeatedly reminded of the monetary, environmental, and self-actualization values' potential of the CUAR. The advertiser is visually and cognitively connected to these values while the User is viewing the stored CUAR. As the CUAR is waiting for pickup, after leaving the consumer unit, the advertising message is exposed to neighbors, visitors, and passers-by, making the ad message ubiquitous. The system User's consumer unit inadvertently becomes a Center of Influence enhancing the value of its User profile to advertisers. In addition, the system allows for new User referral credit in the User profile, repeatedly requalifying the User's capacity as a Center of Influence.

Information regarding the monetary and environmental values of the CUAR is dynamic and public as functions of market exchanges. The data input from these market exchanges supports the system administrator to predict pre-trade estimated value and credit post-trade objective and subjective values.

Prior to pick-up and shipping, but concurrently with presenting the CUAR to the market, the estimated objective value of the contents of the CUAR is enhanced or diminished by the User's CUAR Quality Appraisal Score (factor), a function of the system administrator. The system executes the CUAR trade at this enhanced or diminished objective value and assigns a delivery location to the traded CUAR. The System's User Profile maintains a record of quality factors of each CUAR Trade. (The first pre-trade score is assumed to be perfect (True), or to say, the pre-trade value equals post-trade value). Some of these quality factors are, but not limited to: Contents and weight of contents. Verification of quality factors occurs post-trade, after acceptance of the CUAR by the receiving trade partner; followed by the receiving trade partner's appraisal of the contents. The receiving trade partner reports the CUAR appraisal (True, Absolute) to the system. The System administrator programmatically evaluates the monetary, environmental, and self-actualization “reconciled” valuations of the appraised (True) CUAR and updates the User Profile Trade History with a “Quality” score. This score enhances or diminishes the pre-trade, expected market value of future CUAR trades.

By way of example, a pre-trade CUAR has been identified as packed with electronics (lap-top). The post-trade appraisal confirms the content of the received CUAR is a laptop. The User's CUAR Quality Appraisal Score is perfect (numbering system to be determined). The system administrator programmatically evaluates the monetary, environmental, and self-actualization “reconciled” valuations of the appraised (True) CUAR and updates the User Profile Trade History with a perfect “Quality” score. Considering the same CUAR scenario, but the post-trade appraisal reveals the content of the received CUAR is textiles, not electronics. The User's CUAR Quality Appraisal Score is imperfect. Thus, the value of the textiles are appraised and reported to the system and appropriate evaluation ensues. The system administrator programmatically evaluates the monetary, environmental, and self-actualization “reconciled” valuations of the appraised (True) CUAR and updates the User Profile Trade History with an imperfect “Quality” score. The subsequent tradable CUAR from this unique User is enhanced or diminished pre-trade by the User Profile Historical Quality Score. The score is dynamic as the User trade history develops.

Another activity executed by the system administrator, based on the content reported to the system by the User's scan of the identification insignia on the CUAR, is to offer the CUAR for trade to the appropriate trade markets. Based on the identifying insignia the CUAR will make its way to the (trade recipient) designated materials handling destination by means of established logistics systems. Examples of destinations could be, but not limited to, a non-profit organization, a recycling center or materials recovery operation, a closed-loop manufacturer, a waste-to-energy plant or other designated restorative materials handlers.

A request by the system User for a CUAR no-charge pick-up created the opportunity to trade the User “quality-rated” CUAR at its highest value use and triggered a suite of activities to be executed by the system. One of these activities might include but are not limited to: contacting the appropriate logistics partner for pick-up. At pick-up by a logistics provider, the content insignia on the exterior of the CUAR is scanned, read, and reported programmatically, to the system server, along with the consumer unit unique identification (address). The system instructs the logistics provider of the delivery location (as CUAR has been traded).

Additionally, a confirmation of pick-up and a notice of estimated monetary, environmental, and a self-actualization value of the content specific CUAR, calculated by the system administrator, is forwarded to the User. The User is made aware of these estimated monetary, environmental, and self-actualization values, for example, by opening an email or text message from the system prompting the User to access his system account. Simultaneously, the User's scanning mechanism, likely a mobile phone, measures User's metabolic attributes such as heart rate, body temperature, (to be determined) and continues to measure metabolic attributes as the system prompts the User to respond to questions about the CUAR active trade experience. The system administrator programmatically evaluates the User's metabolic attributes and voluntary answers to system questions in relation to, for example, cognitive, physical, and emotional effects relative to the experience. The system updates the User profile with these measured effects.

The User's metabolic effects are measured as relative to this “awareness” of pending wealth credits and the system administrator updates the User profile with these measured effects. The system notice may include references to the sponsoring advertisers of this specific CUAR. The advertiser would be visually and cognitively connected to these values while the User is viewing the notice, yet, another opportunity for the advertiser to relate to the User.

Regarding appraisal of the CUAR, the system has instructed the logistics partner where to deliver the traded CUAR. The CUAR trade recipient processes and appraises the CUAR based on the actual contents and their value in real-time. The receiving trade partner reports the CUAR appraisal (True, Absolute) to the system. The system administrator programmatically evaluates the objective and subjective “reconciled” valuations of the appraised (True) CUAR. Any adjustment in the objective values defaults to adjust pre-trade estimated subjective values of the appraised post-trade CUAR unit and objective and subjective values are credited the User's system account. The objective values might include, but are not limited to: Currency value from the trade revenue (payment for goods at the highest value use), a dollar representation of the free container, and free shipping, a dollar representation of time saved and disposal charge reductions, an account of coupons and/or discounts offered by the sponsoring advertiser as a results of the CUAR trade process, and if appropriate, tax deduction receipt accounting valuation issued.

After the traded CUAR has been processed and appraised, and reported to the system by the trade recipient, the (absolute) objective values of the true contents of the CUAR are programmatically calculated by the system administrator. These (absolute) objective values might be, but not limited to, monetary and environmental wellness (sustainability). Post-trade the Monetary values of the true contents of the CUAR are credited to the User's system account. The Monetary values might include, but are not limited to: Currency value from the trade revenue (payment for goods at the highest value use), a dollar representation of the free container, and free shipping, a dollar representation of time saved and disposal charge reductions, an account of coupons and/or discounts offered by the sponsoring advertiser as a results of the CUAR trade process, and if appropriate, tax deduction receipt accounting valuation issued. The User account will include historical data regarding quantity and quality of processed CUARs and earned objective wealth balances. In addition, the post-trade objective Earth Wellness values of the true contents of the CUAR are credited to the User's system account. The Earth Wellness values might include but are not limited to: Natural resources protected or saved because of the restorative methods of the system and the User's contribution by participating; preservation of ecosystems and reduction of pollutants and waste. The economic valuation (reduced externalities) attributable to Earth Wellness values include contributions to global supply stability, reduced dependency on resource markets and reduced public cost of processing waste.

The system notifies the User of these absolute objective values posted in their User Profile. The User is made aware of these absolute values, for example, by opening an email or text message from the system prompting them to access their system account. Simultaneously, the User's scanning mechanism, likely a mobile phone, continues to measure User's metabolic attributes such as heart rate, body temperature, (to be determined) as the system prompts the User to respond to questions about the completed CUAR trade experience. The system administrator programmatically evaluates the User's metabolic attributes and voluntary answers to system questions in relation to, for example, cognitive, physical, and emotional effects relative to the total experience. The User's metabolic effects are measured as relative to the awareness of the “granted” (earned) wealth credits and subjective values are re-calculated.

The system has informed the User that there is objective and subjective values' potential in the action of packing the CUAR for trade. After User request pick-up of the filled CUAR, a confirmation of pick-up and a notice of estimated objective and subjective values of the content specific CUAR, calculated by the system administrator, is forwarded to the User. After the traded CUAR has been processed and appraised, and reported to the system by the trade recipient, the (absolute) values of the true contents of the CUAR are programmatically re-calculated by the system administrator. The User is made aware of these objective and subjective values, for example, by opening an email or text message from the system prompting the User to access his system account.

The Self-Actualization values of participating in the system accumulate over the span of the User's CUAR trade experience. Thus, the system administrator, after accumulating the system User's metabolic responses and articulated responses obtained by way of surveys throughout the completed trade experience, calculates the total self-actualization values realized by the User. The total subjective values of the User's system experience are quantified programmatically by way of the system administrator to explain, for example, cognitive, physical, and emotional effects relative to the complete experience (an experience accompanied by a brand-with-image partner message). These subjective values might include, but are not limited to: Feelings of joy, gratitude, safety, influence, good citizenry, charity, and sense of accomplishment of making real social impact. More specifically, system participation evokes JOY, the most desired emotion, to direct the experience of the User into action. The User account will include historical data regarding earned subjective value balances.

The value of the User's total system experience is quantified programmatically by way of the system administrator to explain, for example, cognitive, physical, and emotional effects relative to the total experience (an experience accompanied by a brand-with-image partner message). The User Profile is updated with these realized monetary, environmental, and self-actualization values. Throughout the User experience the system notice of “granted” wealth credits may include references to the sponsoring advertisers of this specific CUAR. The advertiser is visually and cognitively connected to these values while the User is experiencing the system and method. Thus, presenting a higher-value system User experience equates a higher value advertising opportunity.

Objective values are important to the advertiser. The objective values of the User's system experience relevant to the advertiser are calculated based on User behavior by way of the system administrator and are represented to the advertiser as tallied reach and frequency; referrals; life-time value of new customer activity; validated target market membership; specific zip+4 code margins/results; or a combination thereof. Additionally, the advertiser and the image partner are notified by the system administrator of the progress of the CUAR trade. This gives the advertiser and or image partner a signal to contact the User. The system monitors these contacts for evidence of message acceptance and “Premium User Behavior”. Some of these behaviors, commencing by way of the system administrator, might be redemption of a discount or rebate offered by the advertiser; responding to an advertiser's offer to open a credit account; downloading the advertiser's or image partner's APP; accessing the advertiser's website; click-through to purchase; and/or purchasing a customized offer based on the User profile. These communications between the User and the advertiser equates to a higher value User Profile.

Subjective values are also important to the advertiser. The subjective value of the User's system experience is quantified programmatically by way of the system administrator, by measuring, for example, cognitive, physical, and emotional effects of the trade experience relative to a brand-with-image partner message. The User's cognitive, physical and emotional experience constructs of joy, gratitude, safety, influence, good citizenry, charity, sense of accomplishment, peace of mind, or combination thereof translate by way of empirical evidence scales to rate for example, but not limited to, TRUST, INFLUENCE, LOYALTY, and KNOWLEDGE CREATION from the User's perceptions of the advertiser and image partner. The User Profile is updated with these “realized” subjective values. Thus, presenting a higher-value system User experience equates a higher value advertising opportunity.

Regarding the pricing after user profile transformation, to assess the impact of marketing expenditures on customers, it is important to understand the following five key dimensions: (1) Customer Awareness, which includes the extent and ease with which the customer recalls and recognizes the firm and can identify the products and services associated with the firm; (2) Customer Association, which includes the strength, favorability and uniqueness of perceived attributes and benefits of the firm and the brand; (3) Customer Attitudes, which include the customer's overall evaluation of the firm and the brand in terms of its quality and the satisfaction it generates; (4) Customer Attachment, which includes how loyal the customer is toward the firm and the brand; (5) Customer Experience, which includes the extent to which customers use the brand, talk to others about the brand and seek out brand information, promotions, etc. Regarding the Economic Value of CUAR Ad Exposures, advertisers will pay for CUAR User impressions @ $ X+Cost-per-1000 Views because Reach and Frequency distribution, as demonstrated by the system and method of the present invention, are two of the most significant factors/criteria for ad practitioners when selecting media. While in the states of placement, packing, storage, and processing the advertising message on the CUAR is repeatedly viewed and touched (what the ad industry refers to as impressions) by the occupants of the User unit. These CUAR advertising impressions rise above the clutter of competing advertising messaging to an exemplary level of constant impression without competition. It is estimated that on average the User is “uniquely impressed” by the CUAR advertising message 96 times a day. Thus, with each impression, the advertiser is visually and cognitively connected to objective, i.e., monetary values rewarded by the system and subjective values rewarded by the system, such as joy, gratitude, safety, influence, good citizenry, charity, sense of accomplishment, peace of mind, or combination thereof, while the User is placing, packing, storing and processing the trade of a CUAR.

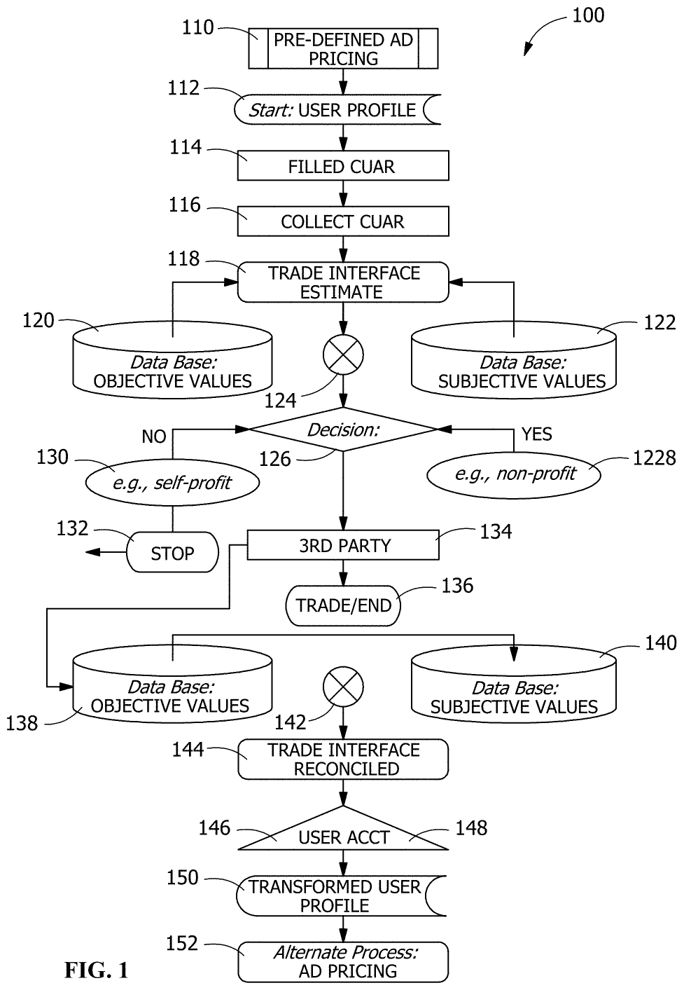

FIG. 1 provides a flowchart of an exemplary embodiment of method/process 100 of the present invention, wherein predefined ad pricing is determined at step 110; a user profile is created at step 112; a CUAR is filled at step 114; the filled CUAR is collected at step 116; a trade interface estimate is generated at step 118 based on input from objective values database 120 and subjective values database 122 by way of summing junction 124 and is shared with the user; a decision is then generated at step 126, wherein if the decision is no, a self-profit outcome is determined at step 130 and the system stops at step 132, and wherein if the decision is yes, a non-profit determination is generated at step 128 and a third party interface is accessed at step 134. The trade process then terminates at step 136. At step 138 the third-party trade recipient reports an appraised objective value of the contents of the CUAR to the system. Any adjustment in the (appraised) objective value reported to the system defaults at step 140 to adjust estimated subjective values. The reconciled objective and subjective values are generated by way of summing junction 142 and reported to the system trade interface at step 144. At step 146 the reconciled objective values are posted to the user account. At step 148 the system posts the reconciled subjective values to the user account and notifies the user of these values. Accumulated information regarding the user system experience conspires at step 150 to update and transform the user profile. At step 152 an alternate advertising opportunity price is generated for the user profile.

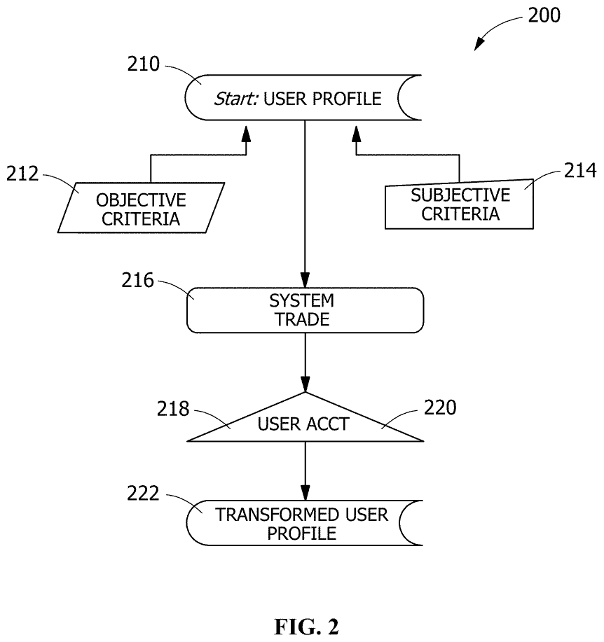

FIG. 2 provides a flowchart of an exemplary embodiment of method/process 200 of the present invention, wherein the existing user profile at step 210 is updated with unique objective criteria at step 212 and unique subjective criteria at step 214. The user's system trade experiences over time accumulate at step 216. The system calculates the total objective values of the user experience and updates the user account with these objective values at step 218. The system calculates the total subjective values of the user experience and updates the user account with these subjective values at step 220. At step 222 the user profile is transformed by these user experience values.

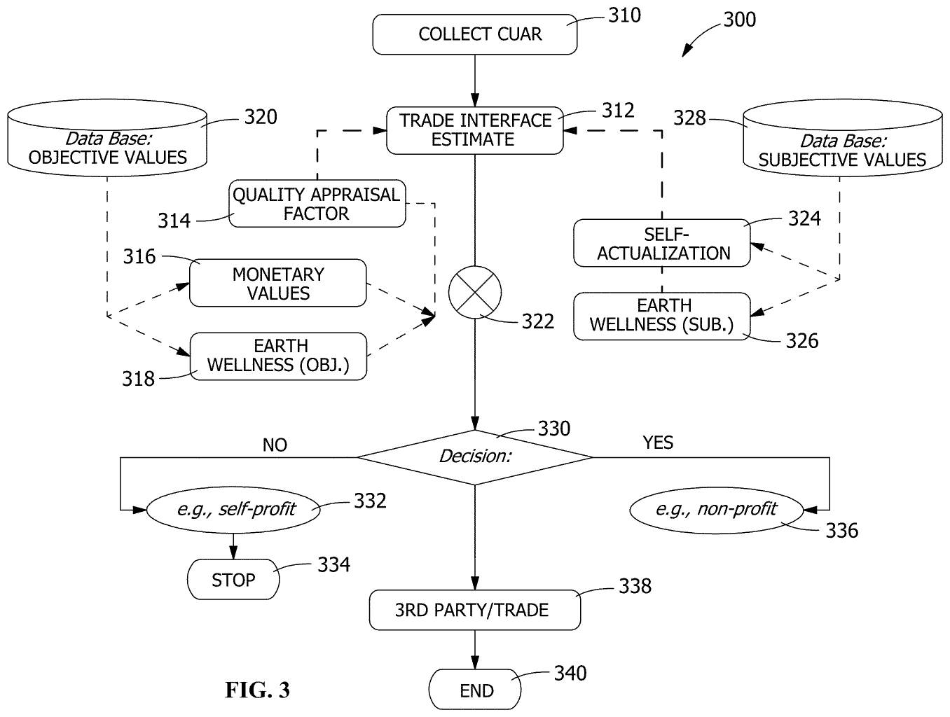

FIG. 3 provides a flowchart of an exemplary embodiment of method/process 300 of the present invention, wherein, at step 310, the filled CUAR is collected. At step 312, the system collects information regarding an estimated value of the contents of the CUAR. This system estimate is based on information collected at step 320 from real-time, objective value market databases. The monetary (currency) values accumulate at step 316 as a result of information from existing public trade markets. At step 318, earth wellness objective values (i.e., as natural resources protected or saved, and reduction in pollutants and waste), accumulate and are estimated as a result of information from existing earth resources databases. The total objective value is enhanced or diminished at step 314 by the system action of applying the user's unique “quality of appraisals” factor. In addition, the system estimate of subjective value is based on information collected at step 328 from real-time subjective value databases. At step 324, the self-actualization value or meaningfulness of the user experience is estimated from the accumulated information. At step 326, the subjective earth wellness values (such as good citizenry and environmental stewardship) accumulate and are estimated as a result of information from existing subjective databases. The total of all subjective and objective values collected by the system at step 312 accumulate by way of summing junction 322 and is shared with the user; a decision is then generated at step 330, wherein if the decision is no, a self-profit outcome is determined at step 332 and the system stops at step 334, and wherein if the decision is yes, a non-profit determination is generated at step 336 and a third party interface is accessed at step 338. The trade process terminates at step 340.

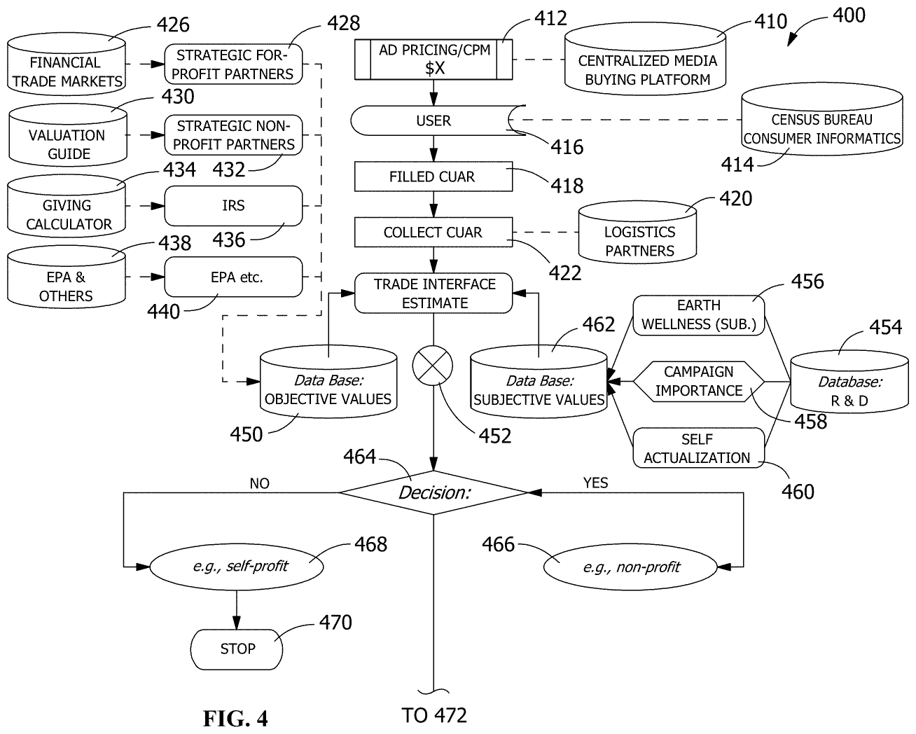

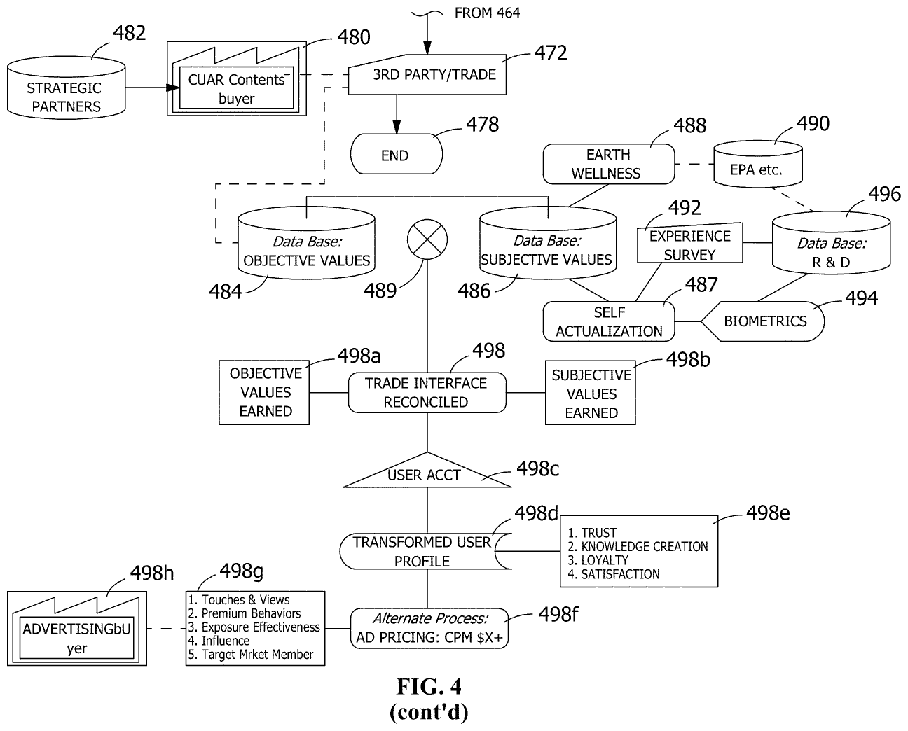

FIG. 4 provides a flowchart of an exemplary embodiment of method/process 400 of the present invention, wherein, at step 412, the system accesses base advertising pricing by linking to centralized media buying platforms, step 410. At step 416 a user account is established on the system server; information about the consumer unit obtained at step 414; by way of linking to public databases and by way of collecting other available information from consumer informatics databases contributes to the user account/profile. At step 418, the user has filled the CUAR and informed the system of a tradable CUAR unit. At step 420, the system contacts the appropriate logistics partner for pick-up and shipping of the filled CUAR, step 422. Prior to pick-up and shipping of the filled CUAR; but concurrently with informing the system of an available tradable unit, the system trade interface, step 424, generates estimated objective and subjective values of the contents of the CUAR. This system objective value estimate is based on information collected at step 450, an objective values database stored on the system server; by way of linking to real-time, objective value market databases. Strategic for-profit partners, step 428, have accesses to the same objective information supplied by step 426; financial trades markets, and present to the system their unique perception of the objective value of the filled CUAR. Strategic non-profit partners, step 432, have access to the same objective information supplied by step 430; valuation guides of philanthropic markets, and present to the system their unique perception of the objective value of the filled CUAR. By linking to the Internal Revenue Service, step 436, the giving calculator function at step 434, informs the system of the tax credits to be granted should the CUAR contents or the trade proceeds thereof, be donated to a non-profit. At step 440, earth wellness objective values (i.e., natural resources protected or saved, and reduction in pollutants and waste), accumulate at and are estimated as a result of information from step 438, existing earth resources databases. The total objective value is enhanced or diminished within step 424, the trade interface, by the system action of applying the user's unique “quality of appraisals” factor. In addition, the system estimate of subjective value is based on information collected on the system server at step 462; by way of linking to real-time, subjective value databases. At step 456, the subjective earth wellness values (i.e., good citizenry and environmental stewardship) accumulate and are estimated as a result of information collected from linking to existing research databases, step 454. Campaign importance, step 458, is estimated as a result of information collected from existing research and development databases, step 454, regarding the enduring and/or instrumental value that might enhance the importance of, for example a call-to-action marketing campaign. At step 460, the self-actualization value or meaningfulness of the user system experience is estimated by way of linking to step 454, empirical research formats and collecting information from other research and development databases. The total of all subjective and objective values collected by the system accumulate by way of summing junction 452 and is shared with the user; a decision is then generated at step 464, wherein if the decision is no, a self-profit outcome is determined at step 468 and the system stops at step 470, and wherein if the decision is yes, a non-profit determination is generated at step 466 and a third party interface is accessed at step 472 by way of linking to a database of strategic partners, step 482, and identifying the CUAR buyer, step 480. The trade process terminates at step 478. The CUAR buyer, step 480, reports the appraised value to the third-party interface, step 472. The system objective value database, step 484, updates the system server with the appraised objective value of the traded CUAR. Also, the total objective value is enhanced or diminished within step 498, the trade interface, by the system action of applying the user's reconciled, unique “quality of appraisals” factor. Any adjustment in the (appraised) objective value reported to the system defaults at step 486 to adjust estimated subjective earth wellness values (i.e., good citizenry and environmental stewardship), step 488. Concurrently, the system subjective database, step 486, is updated with information regarding dynamic, real-time subjective earth wellness values at step 488 collected from step 490 databases and other research databases, step 496. Also, concurrently, at step 487, self-actualization, subjective values of the total user experience is collected by way of linking to user reported data, step 492 and biometric and psychometric data, step 494, collected during the total user system experience. The reconciled total objective and subjective values are generated by way of summing junction at step 489 and reported to the system trade interface at step 498. At step 498a, the reconciled total objective values are posted to the user account, step 498c. At step 498b, the system posts the reconciled total subjective values to the user account, step 498c, and notifies the user of all values. Accumulated information regarding the user system experience conspires at step 498d to update and transform the user profile. Also, at step 498e, user system experience effects valued by the advertiser such as TRUST, INFLUENCE, LOYALTY, and KNOWLEDGE CREATION, which have been tracked by the system throughout the user experience, are calculated in the transformed user profile, step 498g. At step 498f, an alternate advertising opportunity price is generated for access to the transformed user profile. This step 498f is influenced by system analysis of user behavior, step 498g, throughout the total system experience and is offered transformed to the advertising buyer at step 498h.

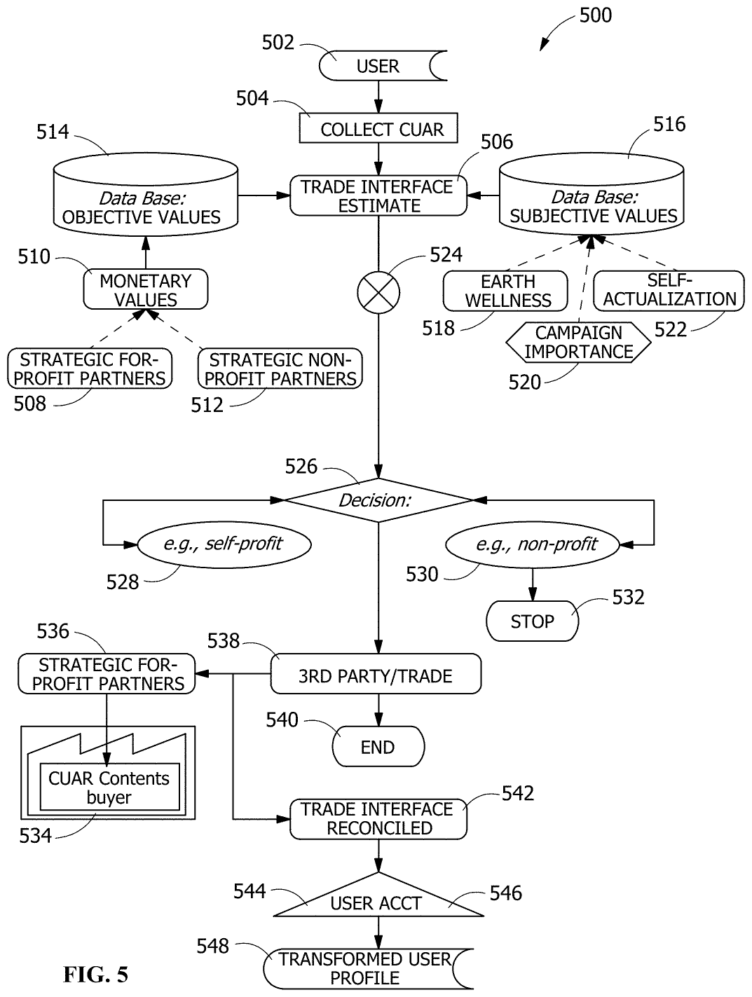

FIG. 5 provides a flowchart of an exemplary embodiment of method/process 500 of the present invention, wherein the system user, step 502, makes a filled CUAR available for collection at step 504. At step 510, monetary values are estimated from information supplied to the system by strategic for-profit partners, step 508, that predict the value of the CUAR if traded in financial markets. Also, at step 510, monetary values are estimated from information supplied to the system by strategic non-profit partners, step 512, that predict the value of the CUAR if traded (i.e., donated) in philanthropic markets. These alternate monetary values, step 510, are stored in the objective values database, step 514. Step 516, the subjective values database, stores information estimated and collected; from step 518, the subjective earth wellness values (i.e., good citizenry and environmental stewardship); from step 520, campaign importance, (i.e., the enduring and/or instrumental value that might enhance the importance of, for example a call-to-action marketing campaign); and from step 522, the self-actualization value or meaningfulness of the trade to the user. At step 506, the system trade interface generates total estimated objective and subjective values for the CUAR trade with a for-profit partner and a total estimate of the alternative objective and subjective values for the CUAR trade with a non-profit partner, by way of summing junction step 524; and shares the alternate estimates with the user. A decision is then generated at step 526, wherein if the decision is yes, a self-profit outcome is generated at step 528 and a third party interface is accessed at step 538; and wherein if the decision is no, a non-profit is determined at step 530 and the system stops at step 532. The trade process terminates at step 540 after acceptance of the CUAR by the buyer, step 534; as processed by a strategic for-profit partner at step 536. The appraised value of the traded CUAR is reported to the system at step 542 by the strategic for-profit partner, step 536. The system posts the reconciled total subjective values to the user account, step 544, and the reconciled total objective values to the user account, step 546; and notifies the user of all values. Accumulated information regarding the user system experience conspires at step 548 to update and transform the user profile.

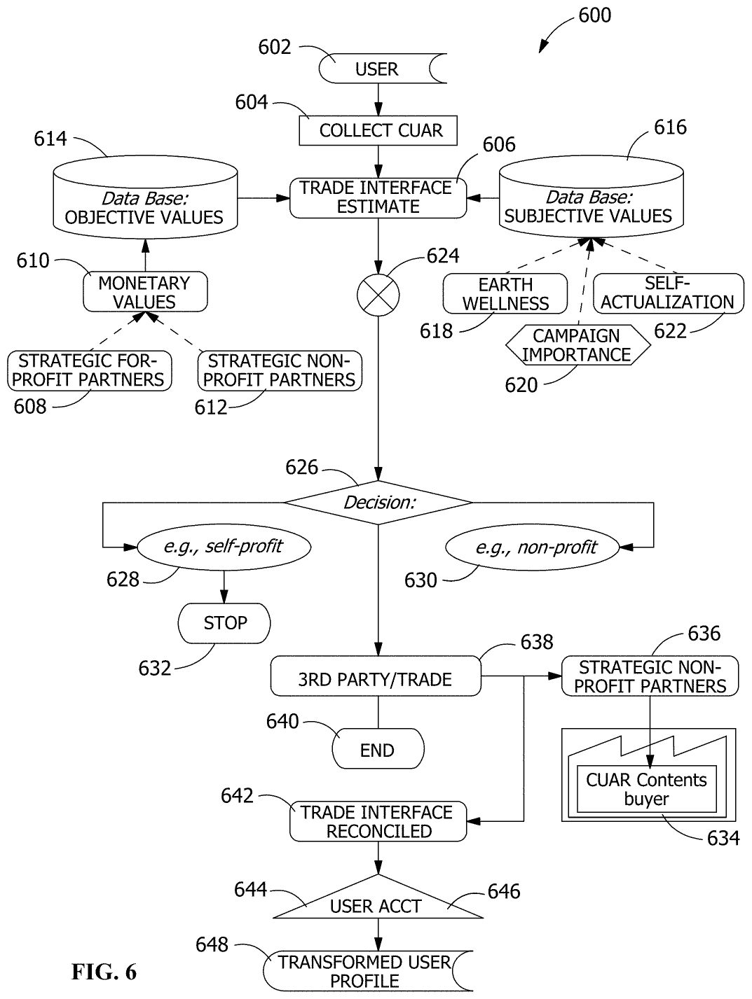

FIG. 6 provides a flowchart of an exemplary embodiment of method/process 600 of the present invention, wherein the system user, step 602, makes a filled CUAR available for collection at step 604. At step 610, monetary values are estimated from information supplied to the system by strategic for-profit partners, step 608, that predict the value of the CUAR if traded in financial markets. Also, at step 610, monetary values are estimated from information supplied to the system by strategic non-profit partners, step 612, that predict the value of the CUAR if traded (i.e., donated) in philanthropic markets. These alternate monetary values, step 610, are stored in the objective values database, step 614. Step 616; the subjective values database stores information estimated and collected; from step 618, the subjective earth wellness values (i.e., good citizenry and environmental stewardship); from step 620, campaign importance, (i.e., the enduring and/or instrumental value that might enhance the importance of, for example a call-to-action marketing campaign); and from step 622, the self-actualization value or meaningfulness of the trade to the user. At step 606, the system trade interface generates total estimated objective and subjective values of the CUAR trade with a for-profit partner and an estimate of the alternative total estimated objective and subjective values for the CUAR trade with a non-profit partner, by way of summing junction step 624; and shares the alternate estimates with the user. A decision is then generated at step 626, wherein if the decision is no, a self-profit outcome is determined at step 628 and the system stops at step 632. Wherein if the decision is yes, a non-profit determination is generated at step 630 and a third-party interface is accessed at step 638. The trade process terminates at step 640 after acceptance of the CUAR by the recipient, step 634; as processed by a strategic non-profit partner at step 636. The appraised value of the traded CUAR is reported to the system at step 642 by the strategic non-profit partner, step 636. The system posts the reconciled total objective values to the user account, step 644, and the reconciled total subjective values to the user account, step 646; and notifies the user of all values. Accumulated information regarding the user system experience conspires at step 648 to update and transform the user profile.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A method for creating and enhancing targeted advertising opportunity based on a dynamic user-specific profile, wherein the method is partially automated or fully automated, and comprises:
(a) determining an initial price for advertising at least one product or service;
(b) using a data processor operated by a system administrator, creating a user account that includes an initial user profile, wherein the initial user profile further includes personal information about the user, and wherein the personal information about the user further includes:
(i) objective criteria, wherein the objective criteria further include demographic information; and
(ii) subjective criteria based on individual preferences; and
(c) creating a tradable or purchasable complete unit of advertising and re-use by providing the user with a container for collecting and storing a predetermined type of re-usable material, wherein the container includes identifying indicia regarding the contents of the container, wherein the container further includes advertising for at least one product or service;
(d) collecting the container of re-usable material after the container has been filled with re-usable material by the user;
(e) processing the container of re-usable material, wherein processing the container of re-usable material includes:
(i) determining an objective value of the re-usable material in the container based on:
a) current market value for the re-usable material in the container; and
b) a dynamic user quality appraisal factor, wherein the dynamic user quality appraisal factor includes a score assigned to each user, wherein the assigned score is derived from an assessment of the history and quality of the user's conduct regarding proper use of the container and the history, quality, and type of re-usable material placed in the container by the user; and
(ii) reconciling the value of the re-usable material to reflect the actual value of the re-usable material, wherein the actual value is derived from what a third party agrees it will pay for the re-usable material;
(iii) trading the container to a third party for a price based on the actual value of the re-usable material in the container;
(iv) applying a portion of the actual value of the traded re-usable material to the user account;
(v) applying a portion of the actual value of the traded re-usable material to executing one or more subjective criteria listed in the initial user profile;
(vi) notifying the user that the subjective criteria have been executed; and
(vii) acquiring input from the user regarding the user's perception of the execution of the subjective criteria, wherein the input represents a subjective value associated with the user's experience of processing the container of re-usable material; and
(f) using a data processor, transforming the initial user profile into a transformed user profile based on the objective value associated with the container of re-usable material and the subjective value associated with the user's experience of processing the container of re-usable material; and
(g) providing the user with another container for collecting and storing a predetermined type of re-usable material, wherein the container includes advertising for at least one product or service, wherein the nature of the advertising has been adjusted based on the transformed user profile, and wherein revenue is realized by the system administrator by providing advertisers with enhanced opportunity based on the transformed user profile.

2. The method of claim 1, further comprising providing the user of the system with notice of earned wealth credits granted by established financial markets including, non-profits donation receipts, materials recycling facilities high-value recyclable receipts, waste-to-energy plants credits that lower waste utility bills, retail discounts, time-savings and free shipping valuations, IRS tax deduction receipts, commodity exchanges trade receipts, or combinations thereof.

3. The method of claim 1, wherein the user account further includes information about one or more financial accounts of the user and the physical address of the user or the physical address of re-usable material.

4. The method of claim 1, wherein the system administrator further includes application software adapted for use on mobile devices.

5. The method of claim 1, wherein the system administrator further includes at least one server in electronic communication with the data processor for automatically executing the steps of the method, and wherein the at least one server is in electronic communication with at least one database for storing information about the objective value of the re-usable material and at least one database for storing information about the subjective value of the user's experience of processing the container of re-usable material.

6. The method of claim 1, wherein the demographic information further includes age, gender, location, ethnicity, education, household composition, professional or employment status, income level, or combinations thereof.

7. The method of claim 1, wherein the individual preferences further include personal likes, dislikes, environmental causes, social causes, personal interests, or combinations thereof.

8. The method of claim 1, wherein the advertising for at least one product or service further includes brand-with-image partner messaging.

9. The method of claim 1, wherein the container includes predetermined physical characteristics, and wherein the predetermined physical characteristics further include size, dimensions, volume, weight when empty, weight when full, material composition, or combinations thereof.

10. The method of claim 1, wherein the predetermined type of re-usable material further includes recyclable materials, and wherein the recyclable materials further include metals, glass, or paper.

11. The method of claim 1, wherein the predetermined type of re-usable material further includes computers or computing devices; electronic items; household goods; items of clothing; textiles; reading materials; or office equipment.

12. The method of claim 1, wherein the input from the user regarding the user's experience of processing the container of re-usable material further includes cognitive, physical and emotional effects experienced by the user, and wherein the cognitive, physical and emotional effects further include feelings of joy, gratitude, safety, influence, good citizenry, charity, sense of accomplishment, or combinations thereof.

13. The method of claim 1, wherein the input from the user regarding the user's experience of processing the container of re-usable material further includes data generated by a survey completed by the user upon the execution of the subjective criteria.

14. An automated method for creating and enhancing targeted advertising opportunity based on a dynamic user-specific profile, comprising:
(a) determining an initial price for advertising at least one product or service;
(b) using a data processor operated by a system administrator, creating a user account that includes an initial user profile, wherein the initial user profile further includes personal information about the user, and wherein the personal information about the user further includes:
(i) objective criteria, wherein the objective criteria further include demographic information; and
(ii) subjective criteria based on individual preferences; and
(c) creating a tradable or purchasable complete unit of advertising and re-use by providing the user with a container for collecting and storing a predetermined type of re-usable material, wherein the container includes identifying indicia regarding the contents of the container, wherein the container further includes advertising for at least one product or service;
(d) collecting the container of re-usable material after the container has been filled with re-usable material by the user;
(e) processing the container of re-usable material, wherein processing the container of re-usable material includes:
(i) determining an objective value of the re-usable material in the container based on:
a) current market value for the re-usable material; and
b) a dynamic user quality appraisal factor, wherein the dynamic user quality appraisal factor includes a score assigned to each user, wherein the assigned score is derived from an assessment of the history and quality of the user's conduct regarding proper use of the container and the history, quality, and type of re-usable material placed in the container by the user; and
(ii) reconciling the value of the re-usable material to reflect the actual value of the re-usable material, wherein the actual value is derived from what a third party agrees it will pay for the re-usable material;
(iii) trading the container to a third party for a price based on the actual value of the re-usable material in the container;
(iv) applying a portion of the actual value of the traded re-usable material to the user account;
(v) applying a portion of the actual value of the traded re-usable material to executing one or more subjective criteria listed in the initial user profile;
(vi) notifying the user that the subjective criteria have been executed; and
(vii) acquiring input from the user regarding the user's perception of the execution of the subjective criteria, wherein the input represents a subjective value associated with the user's experience of processing the container of re-usable material; and
(f) using a data processor, transforming the initial user profile into a transformed user profile based on the objective value associated with the container of re-usable material and the subjective value associated with the user's experience of processing the container of re-usable material;
(g) providing the user with another container for collecting and storing a predetermined type of re-usable material, wherein the container includes advertising for at least one product or service, wherein the nature of the advertising has been adjusted based on the transformed user profile, and wherein revenue is realized by the system administrator by providing advertisers with enhanced opportunity based on the transformed user profile; and
(h) providing the user of the system with notice of earned wealth credits granted by established financial markets including, non-profits donation receipts, materials recycling facilities high-value recyclable receipts, waste-to-energy plants credits that lower waste utility bills, retail discounts, time-savings and free shipping valuations, IRS tax deduction receipts, commodity exchanges trade receipts, or combinations thereof.

15. The method of claim 14, further comprising providing the user of the system with notice of earned wealth credits granted by established financial markets including, non-profits donation receipts, materials recycling facilities high-value recyclable receipts, waste-to-energy plants credits that lower waste utility bills, retail discounts, time-savings and free shipping valuations, IRS tax deduction receipts, commodity exchanges trade receipts, or combinations thereof.

16. The method of claim 14, wherein the user account further includes information about one or more financial accounts of the user and the physical address of the user or the physical address of re-usable material.

17. The method of claim 14, wherein the system administrator further includes application software adapted for use on mobile devices.

18. The method of claim 14, wherein the system administrator further includes at least one server in electronic communication with the data processor for automatically executing the steps of the method, and wherein the at least one server is in electronic communication with at least one database for storing information about the objective value of the re-usable material and at least one database for storing information about the subjective value of the user's experience of processing the container of re-usable material.

19. The method of claim 14, wherein the demographic information further includes age, gender, location, ethnicity, education, household composition, professional or employment status, income level, or combinations thereof.

20. The method of claim 14, wherein the individual preferences further include personal likes, dislikes, environmental causes, social causes, personal interests, or combinations thereof.

21. The method of claim 14, wherein the advertising for at least one product or service further includes brand-with-image partner messaging.

22. The method of claim 14, wherein the container includes predetermined physical characteristics, and wherein the predetermined physical characteristics further include size, dimensions, volume, weight when empty, weight when full, material composition, or combinations thereof.

23. The method of claim 14, wherein the predetermined type of re-usable material further includes recyclable materials, and wherein the recyclable materials further include metals, glass, or paper.

24. The method of claim 14, wherein the predetermined type of re-usable material further includes computers or computing devices; electronic items; household goods; items of clothing; textiles; reading materials; or office equipment.

25. The method of claim 14, wherein the input from the user regarding the user's experience of processing the container of re-usable material further includes cognitive, physical and emotional effects experienced by the user, and wherein the cognitive, physical and emotional effects further include feelings of joy, gratitude, safety, influence, good citizenry, charity, sense of accomplishment, or combinations thereof.

26. The method of claim 14, wherein the input from the user regarding the user's experience of processing the container of re-usable material further includes data generated by a survey completed by the user upon the execution of the subjective criteria.
